(19) United States
(12) Patent Application Publication
(10) Pub. No.: US 2024/0237864 A1
(43) Pub. Date: Jul. 18, 2024

(54) Flexible Hose, in Particular Vacuum Cleaner Hose

(71) Applicant: Truplast Kunststofftechnik GmbH, Langgöns (DE)

(72) Inventors: Marco Holst, Bensheim (DE); Dirk Schwan, Langgöns (DE)

(21) Appl. No.: 18/288,171

(22) PCT Filed: Apr. 26, 2022
(86) PCT No.: PCT/EP2022/061103

§ 371 Date: Oct. 24, 2023

(30) Foreign Application Priority Data
Apr. 27, 2021 (DE) 10 2021 002 202.5

(51) Int. Cl. A47L 9/24; F16L 25/00

(52) U.S. Cl. CPC A47L 9/242; A47L 9/248; F16L 25/0036

(57) ABSTRACT

A flexible hose (10), in particular a vacuum cleaner hose, has a wavily profiled inner hose (12), which is surrounded by a substantially smooth sheathing (14) and is provided with a hollow connection piece (18) at at least one end (16). The inner hose with the sheathing extends into the connection piece, the sheathing being fastened to the inner hose by a sheath securing member (20). Also attached to the inner hose is a retaining sleeve (24), which forms a first stop face (28) for the connection piece and has a second stop face (30) for a connecting piece securing member (32) which is fastened to the connection piece in order to fix the latter in a tension- and compression-resistant manner with regard to the inner hose via the retaining sleeve.

### TECHNICAL FIELD

The present invention relates to a flexible hose according to the preamble portion of claim 1. In particular, the invention relates to a flexible vacuum cleaner hose and to the making-up thereof, such as used on a large scale in the industrial environment, in trade and in private households.

### BACKGROUND OF THE INVENTION AND PRIOR ART

Standard vacuum cleaner hoses have a profiled surface in the form of, for example, alternating wave crests and wave valleys, which extend helically with a single start or multiple start or are formed annularly at a blow-molded hose. This profiling has the consequence in vacuuming operation that the hose when sliding over furniture, door, workpiece and bodywork edges frequently snags due to the wave valleys, whereby an increased expenditure of force for the user arises during vacuuming operation. As a consequence of higher levels of snagging it is in addition possible for jerky interruptions of the smooth course of movement of the user during vacuuming operation to occur, which leads to further impairment of ease of vacuuming.

Moreover, frequent snagging at edges causes increasing damage not only to the hose outer circumferential surface, but also to the outer surface of the friction partner, for example a furniture surface. A further negative effect caused by snagging at edges is the resulting development of noise. Frequent knocking of the hard hose outer circumferential surface, for example on the floor, similarly contributes to creation of noise during vacuuming operation.

In order to (also) counteract these problems it was already proposed in the prior art (see, for example, document EP 1 656 873 A2) to provide an inner hose, which is profiled as described above, with a substantially smooth sheathing preferably comprising a fabric or braiding. Hoses braided with, in particular, round monofilaments, flat monofilaments, plied monofilaments and multiple filaments here count as prior art, wherein the monofilamentary or multifilamentary threads of the braiding may even be flocked with short fibers of a thermoplastic plastics material (cf. the document EP 2 363 210 A2). When in connection with the present invention there is mention of a sheathing of the inner hose, there is meant, in particular, braidings of that kind of the inner hose.

In these known hoses the braiding covers the depressions of the wave profile of the hose, as a result of which the hose has a smoothed outer circumferential surface. Better sliding behavior by comparison with conventional hoses is thus present. There is no longer multiple snagging of the hose, whereby the expenditure of force in vacuuming operation also reduces.

By virtue of the supporting effect of the braiding, braided hoses in addition have better mechanical properties by comparison with conventional hoses. Thus, for example, kinking at a braided hose occurs later than in the case of a conventional hose. If the hose is not too tightly braided it is more flexible than a conventional hose because it can more strongly curve and twist until it kinks. With respect to improved appearance, braided hoses additionally offer the possibility of a more flexible external impression by comparison with conventional hoses.

In order that the bending behavior of the hose is improved and not worsened by the supporting braiding it is necessary for the braiding to be loosely applied to the hose and not braided as tightly as possible. As a result, the braiding during bending of the hose can compress until the edges of the mutually parallelly extending threads abut one another. Only then is a significant counter-force opposing the bending movement built up. If, for example, the braiding is too tightly and narrowly braided, the braided hose no longer has substantially better flexibility compared with the standard hose, but can even have stiffer behavior.

The braiding therefore must not be applied too tightly and narrowly to the hose and/or too strongly compressed on the hose. Depending on whether monofilaments, multiple filaments or both threads in a mixture are braided during the braiding the properties of the braiding then vary. In the case of a hose loosely braided merely with monofilaments, thus comparatively thick individual fibers, gaps in covering necessarily arise in the braiding. A maximum coverage of the hose circumference of approximately 80% can be achieved here. If a hose braided in that manner is bent then the threads, which slide on one another, of the braiding displace and thus also the coverage gaps.

On the other hand, with a braiding of stretchable and compressible multiple filaments, thus of bundles of fibers, or a hybrid braiding of monofilaments and multiple filaments, the hose circumference can be braided for complete coverage so that a fabric-like surface arises. Due to the stretchable multiple filaments, braidings of that kind during bending of the hose bear against the outer radius of the bent hose and compress at the inner radius of the bent hose without in that case forming gaps. However, excessive compression of the braiding on the hose may also lead here to an undesired hose stiffening or bulging.

Since flexible hoses of that kind with a profiled inner hose and a substantially smooth sheathing surrounding the inner hose thus have two hose components, which basically are movable relative to one another, i.e. slidable or rotatable, the making-up of such hoses at the ends with connecting members is more complex than in the case of simple conventional non-sheathed hoses. These connecting members—often in the form of a hollow connecting bush—serve the purpose on the one hand of detachably connecting the hose with an end of, for example, a mobile vacuum cleaner or a stationary central vacuum cleaner and on the other hand of detachable connection of the other hose end with a suction nozzle, a suction pipe, a grip piece, a hand-held power tool, or the like. However, the respective connecting member can in principle also be formed as a constituent of the vacuum cleaner or the machine itself or by, for example, the grip piece, the nozzle, etc.

There is no lack of proposals in the prior art with regard to how a suitable connection between the hose components and the connecting members of such a flexible hose can be designed. Thus, for example, there can be inferred from document DE 10 2013 020 687 A1 a suction hose for a vacuum cleaner in which a wound suction channel hose body with ribs at the outer circumference is received in a flexible, substantially smooth hose sheathing which encases the suction channel hose body. Connecting bushes are provided on the suction hose at the suction hose longitudinal ends for connection with the vacuum cleaner or with a hand-held power tool. The connecting bushes each comprise a base body on which a connecting element for plugging to the hand-held power tool or for plugging into the connection of the vacuum cleaner is mounted.

Provided at the respective base body of the connecting bush is a hose receptacle having at the inner side thereof a ribbing in which the ribs at the outer circumference of the hose body engage so that the hose body is received to be secure against rotation and resistant to tension. In that case the base body comprises a tube section in which the hose receptacle is provided, as well as a support flange for rotatable mounting of the connecting element. Hook projections, which serve for rotation-resistant and tension-resistant retention of the hose sheathing, of a hook arrangement are provided at the outer circumference of the tube section near the support flange. The hose sheathing is formed to be shorter than the hose body and at its hose sheathing longitudinal ends has hook receptacles in which the hook projections engage, wherein a securing ring is arranged over the hook projections in order to fix the connection between the hose casing and the base body. The hose sheathing is thus held not at the hose body, but at the base body of the connecting bush.

A disadvantage of this prior art is that repair of such a suction hose is possible only with considerable effort—if at all—because cutting to length of hose body and hose sheathing would require a fresh construction of the hook receptacles in a predetermined size and at a predetermined place of the hose sheathing, which is not readily possible particularly in the case of a braided hose sheathing.

Moreover, a suction hose for a vacuum cleaner, particularly for operation with a hand-held power tool, with a hose section having a flexible dust removal hose body and a flexible sheathing hose body in which the dust removal hose body is arranged is known from document WO 2019/011591 A1, which forms the preamble portion of claim 1. In that case, a flow channel, which is bounded by a hose sheathing of the dust removal hose body, for guidance of a suction flow to the vacuum cleaner extends between longitudinal ends of the hose section.

A connecting member for connection with the hand-held power tool or the vacuum cleaner is arranged at at least one longitudinal end of the hose section, wherein the sheathing/hose body and the dust removal hose body extend into an interior space of a hose receptacle of the connecting member so that the dust removal hose body is sheathed as far as into the hose receptacle by the sheathing/hose body. Features of this solution are that a mounting section of the dust removal hose body projects into the hose receptacle in front of the sheathing/hose body, wherein a retaining element in the form of an adhesive strip or the like, which covers an end face—which is free towards the mounting section of the dust removal hose body—of the sheathing/hose body and which bears against an inner surface of the hose receptacle, is secured to an outer circumferential surface of the sheathing/hose body.

In order to make-up such a suction hose with the connecting member or connecting members either the sheathing/hose body on the dust removal hose body has to be cut to length, which involve a risk of damage to the dust removal hose body, or, however, the sheathing/hose body has to be axially pulled back relative to the dust removal hose body and held before the retaining element is mounted, which is connected with a degree of effort undesired in mass production. In addition, when pulling back a sheathing/hose body from a braiding relative to the dust removal hose body there is additionally a risk of the braiding experiencing excessive compression or bulging behind the connecting member, as already described above in general, so that the suction hose is undesirably stiffened or thickened at this position.

Moreover, a hose system for a machine tool with a connected suction device, which flexibly connects the machine tool and the suction device and comprises a suction hose at which a supply line, particularly a power cable, is externally arranged, is known from document EP 2 614 762 A2. In that case, the power cable can be a usual power cable which has, for example, three individual conductors each with a cross-section of 2.5 square millimeters. The suction hose and the power cable are surrounded by an outer hose, which can be a textile hose.

This suction system has at each of the ends a respective sleeve of two-part construction, wherein a first part of the sleeve has an internal support which is formed to be corrugated or waved at its outer side and onto which one end of the suction hose is plugged. The suction hose can be a conventional bellows hose, wherein a fixed seat of the end of the suction hose is achieved on the inner support by way of an externally fitted clamping ring. The outer hose also ends in the sleeve and, in particular, in front of the end of the suction hose and is covered by the second part of the sleeve. The power cable exiting the outer hose is led out via an opening at the second part of the sleeve. A press seat on the suction hose and the inner support can be provided for fixing the outer hose. Alternatively, adhesion or securing by a further clamping ring can be provided. In order to finally cover the connecting region and form a unitary component the two sleeve parts are pushed together or connected with one another, possibly glued. However, the problems, which were outlined above with respect to the generic prior art, in making-up are also present in this hose system.

### OBJECT

In relation to the outlined prior art the invention has the object of designing a flexible hose, particularly vacuum cleaner hose, with an inner hose, a sheathing and at least one connecting member at the end in such a way that the problems discussed above with regard to the prior art are addressed and, in particular, making-up as well as possible repair of such a hose are simplified.

### ILLUSTRATION OF THE INVENTION

This object is fulfilled by a flexible hose, particularly vacuum cleaner hose, with the features of claim 1. Advantageous embodiments of the invention are the subject of the dependent claims.

According to the invention, in a flexible hose, particularly vacuum cleaner hose—which comprises a inner hose, which is profiled in wave shape and surrounded by a substantially smooth sheathing and which is provided at at least one end with a hollow connecting member into which the inner hose extends by the sheathing and in which the sheathing is secured to the inner hose by way of a sheathing lock, wherein a retaining sleeve is mounted on the inner hose, the retaining sleeve forming a first abutment surface for the connecting member and having a second abutment surface for a connecting member lock which are secured to the connecting member so as to fix the connecting member tension-resistantly and compression-resistantly with respect to the inner hose—the sheathing in the connecting member ends substantially flushly with the end of the inner hose or projects axially beyond the end of the inner hose only slightly, wherein the sheathing lock mechanically positively fixes the sheathing to the outer circumference of the inner hose, whilst the retaining sleeve is mechanically positively secured to the inner circumference of the inner hose.

Due to the fact that the sheathing in the connecting member ends in the region of the end of the inner hose—and not significantly in front of the end of the inner hose so as to, for example, enable securing of the sheathing to the inner hose by an adhesive strip, as in the generic prior art—the inner hose and sheathing can be cut to length at the same time or, however, the sheathing can be cut to length on an inner hose from a previously measured length in simple manner, for example cutting by shears, knife or heat. Since the sheathing in that case is not shorter than the inner hose, there is no risk of the inner hose experiencing damage in a region used at the finished hose.

In the case of a sheathing—which is preferred here—in the form of a braiding of monofilamentary and/or multifilamentary plastics material threads there is, in addition, no necessity to axially move the sheathing on the inner hose, in particular pull it back, in order to fix the sheathing to the inner hose. Thus, there is also no risk, which was explained above with respect to the prior art, of the braiding being undesirably compressed, compacted and/or bulged at the time of making-up of the hose.

The fixing or securing not only of the sheathing, but also of the retaining sleeve for the connecting member is carried out in particularly long-term or permanent manner by mechanically positive connection with the inner hose, wherein use is made of the wave-shaped profiling, which is present in any case at the inner hose, at the outer circumferential side and inner circumferential side. This advantageously makes possible minimization of the component/parts/aids required for this fixing or securing and the work steps necessary for that purpose. This small assembly effort similarly reduces the number of possible sources of error in the making-up of the hose and promotes automation thereof for mass production of flexible hoses.

Moreover, repair of such a flexible hose is particularly simple if, for example, the hose has damage or leakage in the region of the inner hose or the sheathing. Demounting and remounting of connecting member and retaining sleeve are simple to manage by virtue of the mechanically positive connections which are present, as distinct from what would be the case with, for example, adhesive connections. In addition, the (repeated) cutting to length of the sheathing and the inner hose in the case of repair of the flexible hose according to the invention does not introduce any special difficulties, because it is not necessary to take into consideration different lengths of sheathing and inner hose.

Apart from the high level of repair friendliness in the design of the flexible hose according to the invention, not least worthy of additional mention is good compatibility with existing systems. In that regard, the inner hose, the sheathing, the connecting member and the connecting member lock of the flexible hose basically do not have to undergo any change. To that extent, the hose concept according to the invention is equally suitable as a retrofit solution.

In a preferred development of the flexible hose the retaining sleeve is constructed in the form of a collar sleeve, with a sleeve section joinable to the inner circumference of the inner hose and a collar section which is connected with the sleeve section and which forms the first and second abutment surfaces. Such a part is producible in simple manner by injection-molding from a suitable plastics material. By comparison with equally conceivable individual webs protruding in radial direction at the end of the sleeve section, the afore-mentioned collar section has the advantage that no additional measures for sealing the hose have to be undertaken.

In a simplest embodiment at least one projection, which extends in radial direction, for mechanically positive engagement with the wave-shaped profiling of the inner hose can be provided at the outer circumference of the sleeve section of the retaining sleeve. Such an embodiment with individual projections offers itself, for example, when the retaining sleeve is to be detented with a blow-molded hose, which has a cross-sectional profile with alternating wave crests and wave valleys formed annularly one behind the other. In such a case it is also possible for several projections, which extend in radial direction, in the form of an encircling sawtooth profile, or the like, to be provided.

However, it is also possible for a contour, which is complementary with the wave-shaped profiling of the inner hose and which is, in particular, encircling, to be formed at the outer circumference of the sleeve section of the retaining sleeve. In the case of a sheathed, flexible hose, for example, in which the wave-shaped profiling of the inner hose has alternating wave crests and wave valleys, which as seen in circumferential direction of the inner hose extend helically in a single start or multiple start, the contour, which is complementary with the wave-shaped profiling of the inner hose, at the outer circumference of the sleeve section of the retaining sleeve can be a screw contour. Such a retaining sleeve is particularly simple to join to the inner circumference of the inner hose.

In principle, it is possible for the sheathing lock to be mounted, entirely independently of the retaining sleeve, approximately axially in front of the retaining sleeve at the outer circumference of the sheathing so as to mechanically positively fix the sheathing at the same time within the connecting member to the inner hose. However, on the other hand it is preferred if the sheathing lock is arranged axially in the region of the retaining sleeve so that the retaining sleeve at the time of securing the sheathing to the inner hose by way of the sheathing lock forms a counter-bearing for the inner hose, because compression of the hose cross-section can thus be reliably prevented.

In an embodiment particularly preferred for flexible hoses with a braiding, which is formed from monofilamentary small bands, of the inner hose the sheathing lock can comprise a spring steel ring which is mountable on the outer circumference of the sheathing and which mechanically positively fixes the sheathing to the wave-shaped profiling at the outer circumference of the inner hose. However, instead of a spring steel ring use can also be made here of an injection-molded part, for example a slotted plastics material ring, detentable on the sheathing or, however, a flexible part such as, for example, a cord, although this is less preferred with respect to simplest possible construction and mounting of the sheathing lock.

With regard to cost-reducing decrease in component number and simplest possible mounting of the sheathing lock it is further preferred if the sheathing lock is formed integrally with the retaining sleeve.

As a further advantageous alternative to the afore-mentioned spring steel ring the sheathing lock can comprise at least one retaining element which is placeable against the outer circumference of the sheathing and which in the simplest embodiment has at its side facing the sheathing at least one projection which mechanically positively fixes the sheathing to the wave-shaped profiling at the outer circumference of the inner hose.

In an advantageous development of this embodiment the sheathing lock can comprise at least two shell-shaped retaining elements which are pivotably connected in hinge-like manner with the collar section of the retaining sleeve. Thus, with advantage only one part has to be handled when assembling the retaining sleeve and the sheathing lock. In that case, in a particularly economic solution able to be produced in simple manner by injection molding the shell-shaped retaining elements can be connected with the collar section of the retaining sleeve by way of film hinges.

In order to ensure little outlay on additional securing of the shell-shaped retaining elements the shell-shaped retaining elements can in addition be formed to be detentable with the collar section of the retaining sleeve by a detent connection.

A sheathing lock particularly resistant to pulling out is created by a preferred embodiment of the flexible hose in which the or each retaining element has at its side facing the sheathing a plurality of projections which are formed to be web-like or spike-like for the purpose, during joining, of hooking into the sheathing or penetrating the sheathing towards the inner hose. If in that case the projections are preferably inclined towards the end of the inner hose the result is, in particular, simplification of assembly with a tilting of the respective retaining element with respect to the outer circumference of the sheathing in which axially spaced projections can successively enter into engagement with the sheathing.

In a particularly preferred embodiment for a flexible hose capable of discharging, the connecting member, the retaining sleeve and the retaining element or retaining elements with its or their projections can comprise an electrically conductive material, wherein at least one electrically conductive track extending around the inner hose can be provided at the outer circumference of the inner hose and wherein the afore-mentioned projections electrically contact the electrically conductive track. The sheathing lock thus advantageously has a further electrical earthing function.

As an alternative or in addition thereto in the case of a hose embodiment, in which the electrically conductive track is in electrical contact with at least one electrically conductive thread which electrically connects the mutually remote ends of the inner hose as well as extends substantially along a longitudinal axis of the inner hose and transversely to the electrically conductive track and is secured to the outer circumference of the inner hose, the projections can contact the electrically conductive thread.

Finally, a particularly simple and economic embodiment of the flexible hose is beneficial when the connecting member lock has a retaining ring which is securable to the connecting member and which is supported relative to the second abutment surface of the retaining sleeve by way of a spacer formed by a separate spacer sleeve or the shell-shaped retaining elements of the sheathing lock.

Further features, characteristics and advantages of the flexible hose according to the invention will be evident to the person skilled in the art from the following description of preferred embodiments.

### BRIEF DESCRIPTION OF THE DRAWINGS

The invention is explained in more detail in the following by way of preferred embodiments with reference to the accompanying, partly schematic drawings, in which the same or corresponding parts or sections are provided with the same reference numerals—in a given case with a dash (′) for characterization of the second embodiment—and in which:

FIG. 1 shows a side view, which is broken away to the left, of a flexible hose, namely a vacuum cleaner hose, according to a first embodiment of the invention, with an inner hose which is profiled in wave shape and which is surrounded by a sheathing—illustrated in FIG. 1 in a detail—in the form of a braiding which for illustration of details of the inner hose is shown broken open on the left;

FIG. 2 shows a sectional view, which is similarly broken away on the left, of the hose according to FIG. 1 shown broken open in the region of the sheathing, in correspondence with the section line II-II in FIG. 1;

FIG. 3 shows an illustration, which is to enlarged scale by comparison with FIGS. 1 and 2, of the detail Ill in FIG. 2 for illustration of details of how the sheathing of the hose according to FIG. 1 is secured by way of a sheathing lock to the inner hose in a hollow connecting member of the hose, which is in turn tension-resistantly and compression-resistantly fixed relative to the inner hose by way of a retaining sleeve mounted on the inner hose;

FIG. 4 shows a perspective exploded illustration of the hose according to FIG. 1 from obliquely above and front left, with—from left to right—a retaining ring of a connecting member lock, a spacer sleeve, the sheathing lock in the form of a spring steel ring, the inner hose—which is illustrated broken away on the left—with the sheathing shown broken open on the left, the retaining sleeve and the connecting member;

FIG. 5 shows a side view, which is broken away on the left, of the inner hose of the hose according to FIG. 1, with the sheathing which is shown broken open on the left and which is mechanically positively secured to the outer circumference of the inner hose by way of the sheathing lock, and the retaining sleeve mechanically positively secured to the inner circumference of the inner hose, in a state before the connecting member is mounted on the inner hose by way of the connecting member lock via the retaining sleeve;

FIG. 6 shows a perspective view, which is broken away on the left, of the hose according to FIG. 1 from obliquely above and front left with the sheathing shown broken open, after—starting from the state according to FIG. 5—the connecting member was mounted on the inner hose by way of the connecting member lock via the retaining sleeve;

FIG. 7 shows a perspective view of the retaining ring of the connecting member lock of the hose according to FIG. 1 from obliquely above and front left;

FIG. 8 shows a side view of the retaining ring according to FIG. 7;

FIG. 9 shows a sectional view of the retaining ring according to FIG. 7 in correspondence with the section line IX-IX in FIG. 8;

FIG. 10 shows side view, which is broken away on the right, of a flexible hose, namely vacuum cleaner hose, according to a second embodiment of the invention, with an inner hose which is profiled in wave shape and is enclosed by a sheathing in the form of a braiding, which for illustration of details of the inner hose is illustrated broken open on the right, revealing a view of an adhesive strip by which an electrically conductive thread is secured to the outer circumference of the inner hose;

FIG. 11 shows a sectional view, which is similarly broken away on the right, of the hose according to FIG. 10 broken open in the region of the sheathing, in correspondence with the section line XI-XI in FIG. 10;

FIG. 12 shows an illustration, which is to enlarged scale by comparison with FIGS. 10 and 11, of the detail XII in FIG. 11 for illustration of details of how the sheathing of the hose according to FIG. 10 is secured by way of a sheathing lock to the inner hose in a hollow connecting member of the hose, which in turn is again tension-resistantly and compression-resistantly fixed with respect to the inner hose by way of a retaining sleeve mounted on the inner hose, wherein there is illustration in particular of how the sheathing lock also serves for the purpose of electrically contacting at least one electrically conductive track provided at the outer circumference of the inner hose;

FIG. 13 shows a perspective exploded illustration of the hose according to FIG. 10 from obliquely above and back right, with—from right to left—a retaining ring of a connecting member lock, the inner hose, which is shown broken away on the right, with the sheathing illustrated broken open on the right, the retaining sleeve, at which two shell-shaped retaining elements of the sheathing lock are pivotably connected, of which the upper retaining element is shown in a pivoted-up state prior to its assembled end setting, and the connecting member;

FIG. 14 shows a perspective view, which is broken away on the right, of the hose according to FIG. 10 from obliquely above and back right, with the sheathing shown broken open, after—starting from the state according to FIG. 13—initially the retaining sleeve was mounted on the inner circumference of the inner hose, then the sheathing by way of the sheathing lock at the outer circumference of the inner hose and finally the connecting member by way of the connecting member lock via the retaining sleeve at the inner hose; and

FIG. 15 to FIG. 17 show side views, which are broken away on the right, of the hose according to FIG. 10, which by comparison with the illustration in FIG. 10 was turned through 90° about its longitudinal axis, in each instance with the sheathing shown broken open on the right, wherein the side views illustrate different assembly states of the sheathing lock and the connecting member lock on the inner hose.

### DETAILED DESCRIPTION OF THE EMBODIMENTS

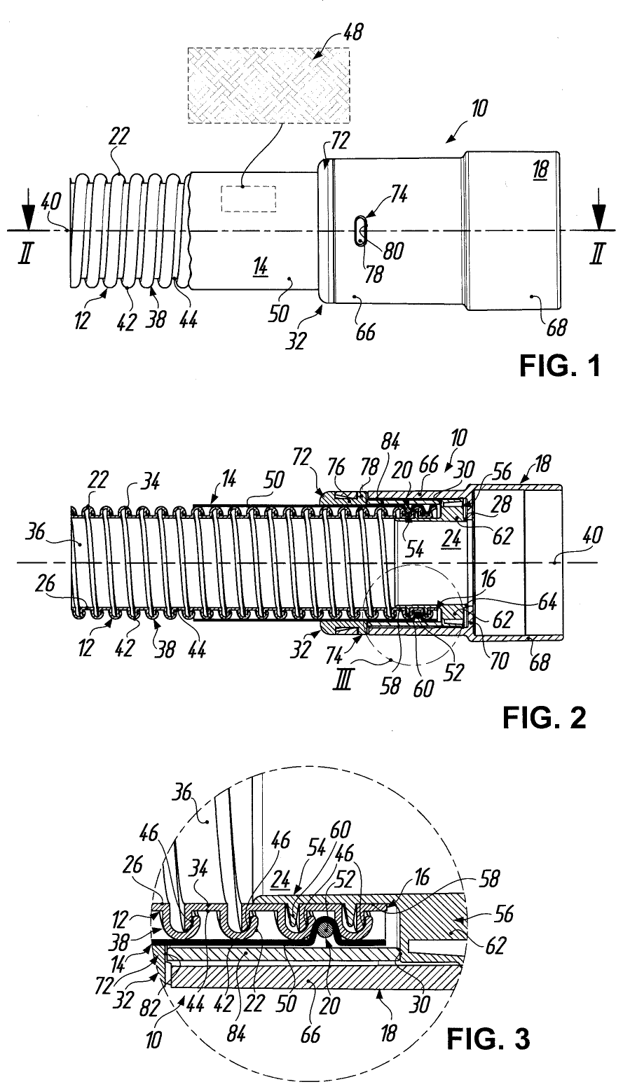

A vacuum cleaner hose is denoted generally by the reference numeral 10 in FIGS. 1 to 4 and 6 as an example for a flexible hose. Merely one end of the hose 10, which depending on the respective purpose of use can be, for example, one meter to several meters long, is illustrated here. The other end of the hose 10 can, but does not have to, be formed correspondingly, which, however, does not matter for an understanding of the present invention.

The hose 10 in general comprises an inner hose 12 which is profiled in wave shape and surrounded by a substantially smooth sheathing 14 and which is provided at at least one end 16 with a hollow connecting member 18 into which the inner hose 12 with the sheathing 14 extends. As will be described in more detail in the following, the sheathing 14 is secured in the connecting member 18 to the inner hose 12 by way of a sheathing lock which mechanically positively fixes the sheathing 14 to the outer circumference 22 of the inner hose 12.

Further, as will be similarly explained in more detail in the following, a retaining sleeve 24 is mounted on the inner hose 12, more precisely mechanically positively secured to the inner circumference 26 of the inner hose 12, the sleeve forming a first abutment surface 28 for the connecting member 18 and having a second abutment surface 30 for a connecting member lock 32. The connecting member lock 32 is secured to the connecting member 18 and in co-operation with the retaining sleeve 24 serves, in a manner to be described in more detail later, the purpose of tension-resistantly and compression-resistantly securing the connecting member 18 relative to the inner hose 12 by way of the retaining sleeve 24.

According to a further important feature the sheathing 14 in the connecting member 18 terminates substantially axially flushly with the end 16 of the inner hose 12 or, however, axially projects merely slightly beyond the end 16 of the inner hose 12. However, the latter is not illustrated in the figures.

According to, in particular, FIGS. 2 and 3, the inner hose 12 has a wall 34 which by its inner circumference 26 bounds a cavity 36 for the conveying of media. At the outer circumference 22 the wall 34 is profiled in wave shape, i.e. it has a profiling 38 which as seen in section along a longitudinal axis 40 of the hose 10 has a wave shape with alternating elevations or wave crests 42 and depressions or wave valleys 44. In the illustrated embodiment the wave crests 42 and wave valleys 44 run helically as seen in circumferential direction of the inner hose 12 in a single start or, alternatively, in a multiple start (not shown here). This is explained by the fact that a wound inner hose 12 is concerned here, i.e. an inner hose 12, the wall 34 of which is formed from a profile helically wound about the longitudinal axis 40, wherein adjacent windings of the profile are media-tightly connected together.

The profile, which is shown here by way of example, of the inner hose 12 has as seen in cross-section two regions, namely a respective region on the left in FIG. 3, the cross-section of which has substantially the form of a letter U in “angular” form of writing and standing on its head and which at the wound inner hose 12 forms the wave valleys 44 of the profiling 38, and a respective region on the right in FIG. 3, which as considered in cross-section has substantially the form of a letter C lying horizontally or tipped through approximately 90° in anticlockwise sense and which at the wound inner hose 12 forms the wave crests 42 of the profiling 38. As can be readily seen in FIG. 3 the C-shaped region of a winding of the profile is quasi “hooked” over the lefthand limb of the U-shaped region of an adjacent winding of the profile so that a short profile overlap arises along the longitudinal axis 40. In the region of this profile overlap there is provided, for example, a hot-melt adhesive 46, which forms a helically encircling seam, for media-tight connection of the adjacent windings of the profile.

In the illustrated embodiment the profile of the inner hose 12 is extruded from a plastics material such as, for example, polyethylene (PE), polypropylene (PP) or an ethylene vinyl acetate copolymer (EVAC). As far as the hot-melt adhesive 46 is concerned, it can similarly comprise a plastics material such as, for example, PE or EVAC.

As the detail at the top in FIG. 1 illustrates, in the illustrated example the sheathing 14 of the hose 12 is a braiding 48 of the inner hose 12 made from monofilamentary and/or multifilamentary plastics material threads, for example from a thermoplastic plastics material such as, for example, polyamide (PA) or PE. The multifilamentary threads when bending of the hose 12 takes place lay on the tension side flatly against the inner hose 12 and compress on the compression side of the inner hose 12 transversely to the threads and thus also towards the wall 34 of the inner hose 12, so that the braiding 48 always bears against the wall 34. In a particularly advantageous mixture ratio of 50% multifilamentary threads to 50% monofilamentary threads, the braided surface of the hose 10 in addition always remains closed.

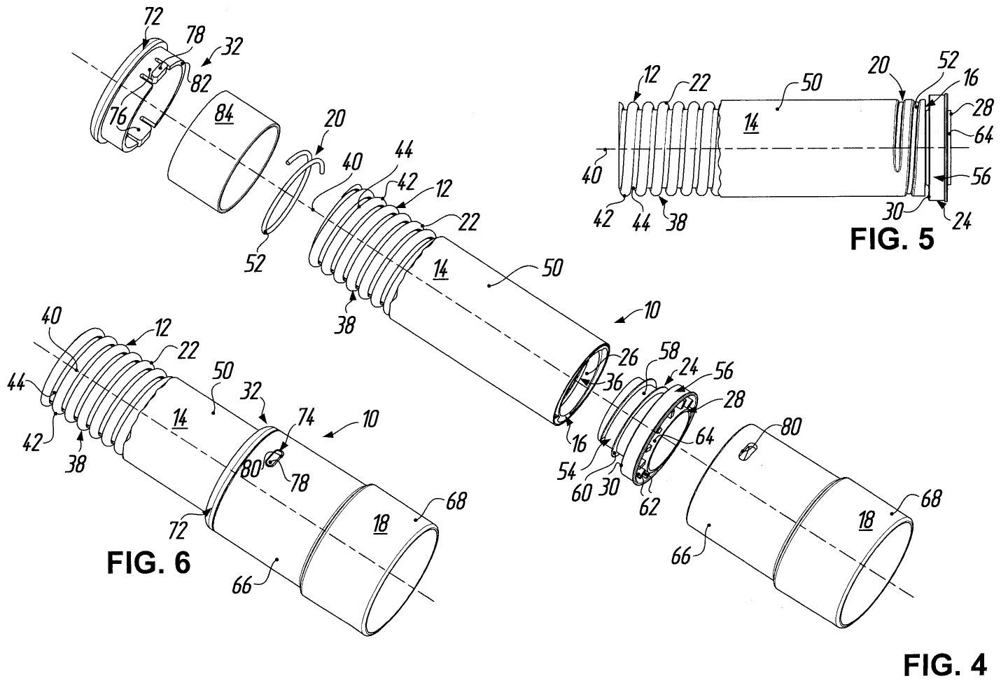

Details of the sheathing lock 20 in the first embodiment are evident particularly from FIGS. 3 to 5. Accordingly, the sheathing lock 20 here comprises a spring steel ring 52 which can be mounted on the outer circumference 50 of the sheathing 14 and which mechanically positively fixes the sheathing 14 to the wave-shaped profiling 38 at the outer circumference 22 of the inner hose 12. As FIG. 3 shows, the sheathing 14 in that case is “drawn” by the spring steel ring 52, which bears against the outer circumference 50 of the sheathing 40, into a wave valley 44 of the profiling 38 of the inner hose 12, so that the sheathing 14 at both axial sides, i.e. to the left and right in FIG. 3, is mechanically positively held at mutually opposite flanks of the profiling 38 of the inner hose 12. As can be seen in FIG. 4, the spring steel ring 52 in that case is constructed in the form of a screw spring, with a complete winding of somewhat more than 360°, for example 400°, about the longitudinal axis 40. The wire diameter of the spring steel ring 52 is in that regard selected to be somewhat smaller than the clear spacing of the opposite flanks of the profiling 38 of the inner hose 12 in the region of the corresponding wave valley 44.

As far as the tension-resistant and compression-resistant fixing of the connecting member 18 to the inner hose 12 provided with the sheathing 14 is concerned, it can be seen first of all in FIGS. 2 to 5 that the retaining sleeve 24 is constructed in the form of a collar sleeve with a sleeve section 54 joinable to the inner circumference 26 of the inner hose 12 and a collar section 56, which is connected therewith in axial direction and which according to FIGS. 2, 4 and 5 forms the first and second abutment surfaces 28, 30. In the illustrated embodiment a contour 60, which is complementary with the wave-shaped profiling 38 of the inner hose 12, is formed at the outer circumference 58 of the sleeve section 54 of the retaining sleeve 24 for mechanically positive securing of the retaining sleeve 24 to the inner circumference 26 of the inner hose 12. More precisely, the contour 60 complementary with the wave-shaped profiling 38 of the inner hose 12 is here a screw contour formed at the outer circumference 58 of the retaining sleeve 24, as can be best seen in FIG. 4.

The outer diameter of the sleeve section 54 of the retaining sleeve 24 with the screw contour 60 formed thereon is in that case adapted to the inner circumference 26 of the inner hose 12 with the profiling 38 thereof in such a way that the retaining sleeve 24 can be screwed into the inner hose 12 like a screw, so that the retaining sleeve 24 by its sleeve section 54 is mechanically positively fixable by way of two—or more—thread turns of the screw contour 60 to the inner circumference 26 of the inner hose 12, as can be readily seen in FIG. 3.

According to, in particular, FIG. 4 the collar section 56 of the retaining sleeve 24 produced from a suitable plastics material by injection molding is stiffened relative to the sleeve section 54 by a plurality of webs 62 uniformly distributed over the circumference. The outer diameter of the collar section 56 of the retaining sleeve 24 is in that regard so adapted to the outer diameter of the inner hose 12 provided with the sheathing 14 that the collar section 56 projects radially beyond the sheathing 14 of the inner hose 12, as can be best seen in FIG. 3. The collar section 56 of the retaining sleeve 24 forms the annular second abutment surface 30 on the hose side by this radial projection. On the other hand, on the side of the retaining sleeve 24 remote from the hose the collar section 56 of the sleeve has an annular projection 64 which forms the annular first abutment surface 28, the radial dimensions of which substantially correspond with the radial dimensions of the sleeve section 54 of the retaining sleeve 24.

The hollow connecting member 18 shown by way of example in FIGS. 1, 2, 4 and 6 is also produced from a suitable plastics material in injection-molding technology. This connecting member 18 is of stepped configuration, with a hose-side sleeve section 66 of smaller diameter and a hose-distal sleeve section 68 of greater diameter, the sections being axially separated by an annular partition wall 70. The partition wall 70 has an inner diameter which approximately corresponds with the inner diameter of the collar section 56 of the retaining sleeve 24, so that the connecting member 18 is able to abut by its partition wall 70 against the annular projection 64 of the retaining sleeve 24, i.e. against the first abutment surface 28 thereof, so as to compression-resistantly fix the connecting member 18 with respect to the inner hose 12 by way of the retaining sleeve 24.

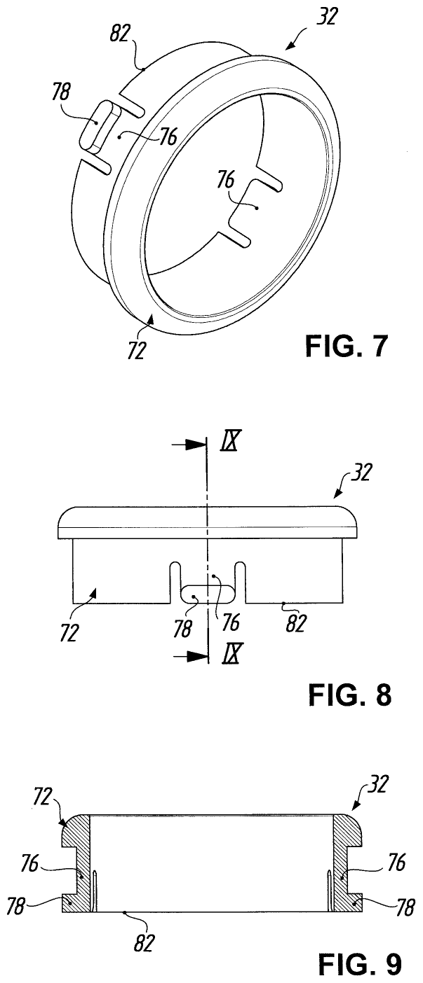

In order to be able to also tension-resistantly fix the connecting member 18 with respect to the inner hose 12 by way of the retaining sleeve 24 the connecting member lock 32 has a retaining ring 72 which is known per se and which can be secured to the connecting member 18. For that purpose, provided between the connecting member 18 and the retaining ring 72 is a detent connection 74 formed by spring arms 76 with detent lugs 78 at the retaining ring 72 (see, in particular, FIGS. 7 to 9) and associated detent windows 80 at the connecting member 18. In the state of the retaining ring 72 being detented to the connecting member 18 the retaining ring 72 forms by its annular end surface 82 facing the connecting member 18 a counter-bearing for a spacer, here in the form of a separate hollow cylindrical spacer sleeve 84, which in turn is capable of support on the second abutment surface 30 at the collar section 56 of the retaining sleeve 24.

It will be apparent to the person skilled in the art that compressive forces exerted on the connecting member 18 in the direction of the inner hose 12 are introduced by way of the partition wall 70 of the connecting member 18 into the first abutment surface 28 at the annular projection 64 of the collar section 56 of the retaining sleeve 24 and thus into the retaining sleeve 24. In that case the retaining sleeve 24 is axially supported by its screw contour 60 at the outer circumference 58 of the sleeve section 54 on the wall 34, which is of wave-shaped profile, of the inner hose 12. If, on the other hand, tension forces are exerted on the connecting member 18 from the direction of the inner hose 12 then these pull by way of the detent connection 74 against the retaining ring 72, which in turn pulls by way of its end surface 82 the spacer sleeve 84 against the second abutment surface 30 at the collar section 56 of the retaining sleeve 24. The forces are thus again introduced into the retaining sleeve 24, which in that case is again axially supported by its screw contour 60 at the outer circumference 58 of the sleeve section 54 on the wall 34, which is profiled in the wave shape, of the inner hose 12, this time, however, in the opposite direction, i.e. in the direction away from the inner hose 12.

Finally, it can also be seen in, in particular, FIG. 3 that in the embodiment illustrated here the sheathing lock 20 is axially arranged in the region of the retaining sleeve 24 so that the retaining sleeve 24 when the sheathing 14 is secured to the inner hose 12 by way of the sheathing lock 20, more precisely the spring steel ring 52 of the sheathing lock 20, also forms a radial counter-bearing for the inner hose 12. The arrangement is in that case undertaken in a physically very compact manner so that according to FIG. 3 the spring steel ring 52 of the sheathing lock 20 lies axially between adjacent windings of the screw contour 60 at the outer circumference 58 of the sleeve section 54. In the mounted state of the connecting member 18 the spacer sleeve 84 of the connecting member lock 32 in that case covers the spring steel ring 52 of the sheathing lock 20 so that the spring steel ring 52 is not capable of radially outward movement from its mechanically positive couple with the sheathing 14 and profiling 38.

The afore-described flexible hose 10 can be made up, for example, as follows: Firstly, the profiled inner hose 12 is cut to predetermined length and braided with monofilamentary and/or multifilamentary plastics material threads in order to form the substantially smooth sheathing 14. The ends of the sheathing 14 are then axially cut in front of or at the ends 16 of the inner hose 12 so that the sheathing 14 at the ends 16 of the inner hose 12 terminates at least flushly with the ends 16 of the inner hose 12. This state is illustrated in FIG. 4 for one end of the hose 10.

In order to mount the (respective) connecting member 18 initially the retaining ring 72 and the spacer sleeve 84 of the connecting member lock 32 as well as the spring steel ring 52, which is expanded in radial direction against the spring force, of the sheathing lock 20 are pushed over the end 16 of the inner hose 12 provided with the sheathing 14 cut to length. The retaining sleeve 24 is then screwed by its sleeve section 54, more precisely the screw contour 60 formed thereon, into the profiled inner hose 12 until the end 16 of the profiled inner hose 12 is disposed in the immediate vicinity of the collar section 56 of the retaining sleeve 24 (cf. FIG. 3). The spring steel ring 52 of the sheathing lock 20 is thereafter axially positioned in the direction of the collar section 56 over the sleeve section 54 of the retaining sleeve 24 and relieved of stress so that the spring steel ring 52 draws the sheathing 14 into the profiling 38 of the inner hose 12. This state is shown in FIG. 5. It will be evident that when mounting this sheathing lock 20 a relative sliding or rotation between sheathing 14 and inner hose 12 is not necessary or does not take place, so that the sheathed hose does not undergo any change in front of the connecting member 18.

Subsequently, the spacer sleeve 84 and the retaining ring 72 of the connecting member lock 32 are pushed in the direction of the collar section 56 of the retaining sleeve 24 until the end of the spacer sleeve 84 facing the collar section 56 abuts against the second abutment surface 30 at the collar section 56 and the retaining ring 72 by its end surface 82 at the end remote from the collar section 56 comes into contact with the spacer sleeve 84.

The connecting member 18 can now be pushed with its sleeve section 66 foremost over the collar section 56 of the retaining sleeve 24 and positioned in circumferential direction about the longitudinal axis 40 until at the reference numeral 74 in FIG. 6 a detenting of the detent lugs 78 at the spring arms 76 of the retaining ring 72 with the associated detent windows 80 in the connecting member 18 takes place.

Demounting of the connecting member 18 and the connecting member lock 32 for repair work on the hose 10 can be carried out in reverse sequence, for which purpose the spring arms 76 at the retaining ring 72 have to be deflected in radial direction so as to release the detent connection 74. If the retaining sleeve 24 is thereafter freed as shown in FIG. 5, the retaining sleeve 24 can be unscrewed by its screw contour 60 from the profiled inner hose 12. Removal of the spring steel ring 52 of the sheathing lock 20 from the sheathed inner hose 12 now also takes place in simple manner. The sheathing 14 and the inner hose 12 can thereafter be newly cut to length as desired before fresh making-up of the hose 10 as described above is concluded by mounting the retaining sleeve 24 on the inner circumference 26 of the inner hose 12, the sheathing lock 20 on the outer circumference 50 of the sheathing 14 and the connecting member 18 on the retaining sleeve 24 by way of the connecting member lock 32.

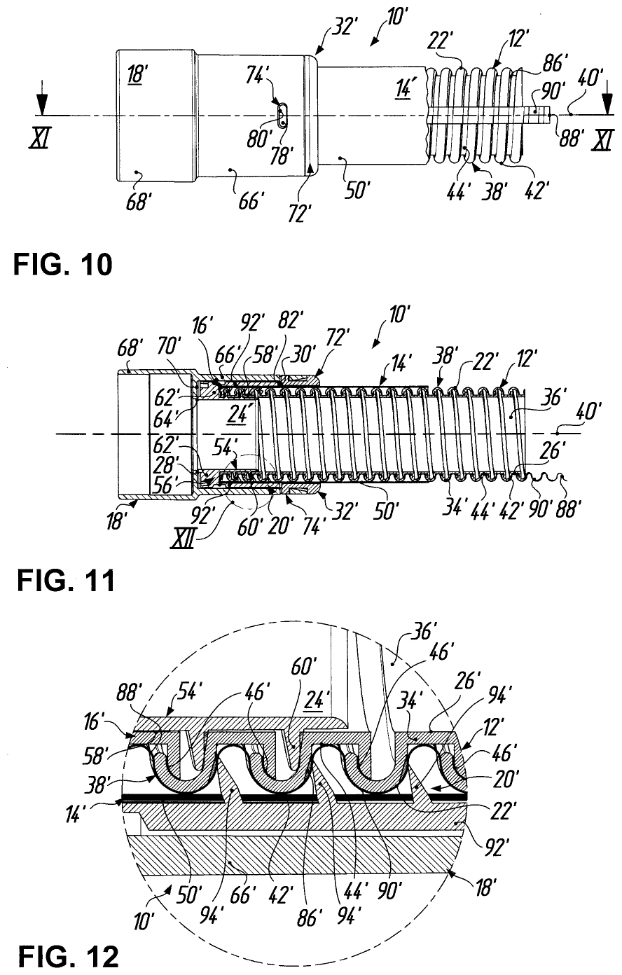

The second embodiment of the flexible hose 10′ will now be described in the following with reference to FIGS. 10 to 17 only to the extent that it significantly differs from the afore-described first embodiment of the hose 10. In that regard, the same reference numerals supplemented by a dash (′) denote components or subassemblies of the second embodiment which are the same as or correspond with those of the first embodiment.

First and foremost, the inner hose 12′ of the flexible hose 10′ according to the second embodiment is constructed differently from the first embodiment. As best recognized in FIGS. 12 to 14, provided at the outer side of the wall 34′ is, in particular, at least one electrically conductive track 86′ which extends around the wall 34′ and serves the purpose of collecting and passing on electrostatic charges. The electrically conductive track 86′ is in electrical contact with at least one electrically conductive thread 88′, which connects mutually remote ends 16′ of the inner hose 12′ so as to conduct the electrostatic charges thereto. In that case, the electrically conductive thread 88′ according to FIGS. 10, 13 and 14 runs substantially along the longitudinal axis 40′ of the hose 10 and transversely to the electrically conductive track 86′ or crosses the latter. The electrically conductive thread 88′ is secured to the outer circumference 22′ of the wall 34′, as can be seen in, in particular, FIGS. 12 to 14. More precisely, the at least one electrically conductive thread 88′ in this embodiment is secured by an adhesive strip 90′ to the outer side of the wall 34′, which as seen in circumferential direction of the inner hose 12′ covers the electrically conductive thread 88′ to both sides.

Such a hose 10′ or inner hose 12′ capable of discharge is the subject matter of earlier German patent application DE 10 2020 006 493.0 of the same applicant, to which for avoidance of repetition express reference may be made at this point with respect to further more detailed construction, the function of the hose and the manufacture thereof.

As, in particular, FIGS. 10, 13 and 14 show, the sheathing 14′—basically unchanged by comparison with the first embodiment—covers the electrically conductive track 86′, the electrically conductive thread 88′ and the adhesive strip 90′ on the inner hose 12′. With respect to the sheathing, it may additionally be noted at this point that the sheathing lock described in more detail in the following for the second embodiment is, in the case of a braiding, quite suitable for sheathings comprising at least a mix of monofilamentary and multifilamentary plastics material threads. For braidings of purely monofilamentary plastics material threads, the sheathing lock described for the first embodiment is preferred.

Whereas the connecting member 18′ and the retaining ring 72′ of the connecting member lock 32′ are of identical construction as for the first embodiment, there are differences in the sheathing lock 20′, the retaining sleeve 24′ and the further construction of the connecting member lock 32′. In particular, here the sheathing lock 20′ is formed integrally with the retaining sleeve 24′, as described in the following.

In general terms, the sheathing lock 20′ in the second embodiment comprises at least one retaining element 92′, which is placeable against the outer circumference 50′ of the sheathing 14′ and which has at its side facing the sheathing 14′ at least one projection 94′ which mechanically positively fixes the sheathing 14′ to the wave-shaped profiling 38′ at the outer circumference 22′ of the inner hose 12′. More precisely, the sheathing lock 20′ here comprises two—or even more—retaining elements 92′, which are of shell-shaped construction and which can be placed against the outer circumference 22′ of the inner hose 12′ so as to produce the discussed mechanically positive couple.

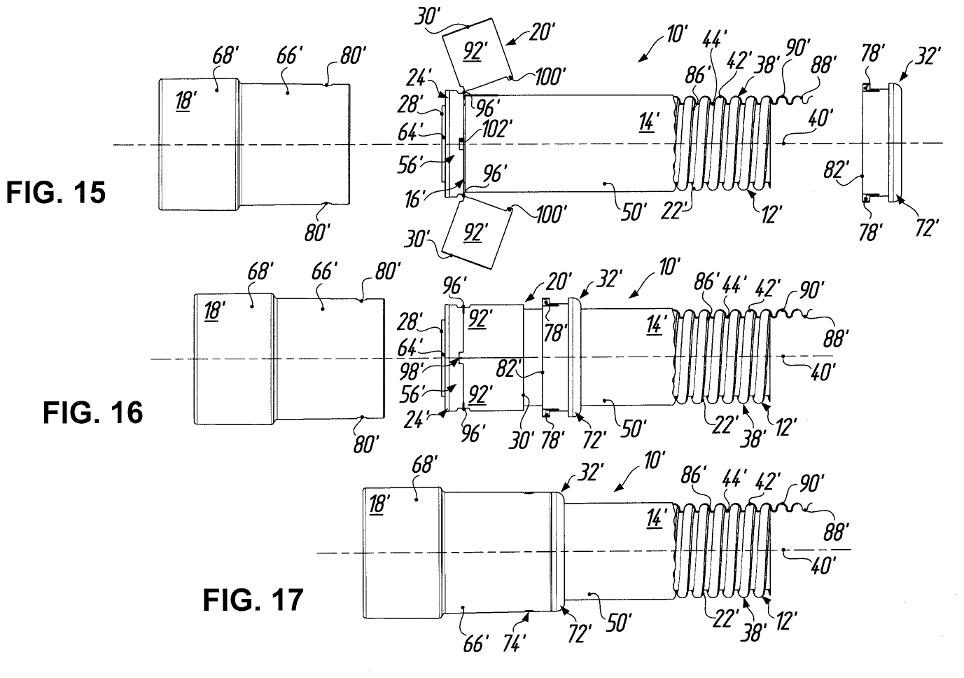

In the illustrated embodiment these retaining elements 92′ are pivotably connected in hinge-like manner with the collar section 56′ of the retaining sleeve 24′, as can be best seen in FIG. 15. In a simple embodiment produced by injection molding the shell-shaped retaining elements 92′ are here coupled by way of film hinges 96′ to the collar section 56′ of the retaining sleeve 24′ and, in particular, on the side of the sleeve section 54′ of the retaining sleeve 24′. Similarly, it can be inferred from, in particular, FIGS. 15 and 16 that the shell-shaped retaining elements 92′ are detentable with the collar section 56′ of the retaining sleeve 24′ by way of a detent connection 98′. For that purpose a detent lug 100′ which can detent with an associated detent cut-out 102′ in the collar section 56′ of the retaining sleeve 24′ is provided at each retaining element 92′.

In that respect it will be apparent to the person skilled in the art by comparison of FIGS. 2 and 3 of the first embodiment with, in particular, FIGS. 11, 13 and 16 relating to the second embodiment that in the second embodiment the shell-shaped retaining elements 92′—analogously to the spacer sleeve 84 in the first embodiment—are similarly functional components of the connecting member lock 32′ serving the purpose of transmitting to the retaining sleeve 24′ a tension force which is exerted on the connecting member 18′ in a direction away from the hose 10′ and which acts by way of the retaining ring 72′ detented with the connecting member 18′ on the second abutment surface 30′ formed by the retaining elements 92′, so that they can be supported on the profiling 38′ of the inner hose 12′ by the screw contour 60′ of the retaining sleeve 24′.

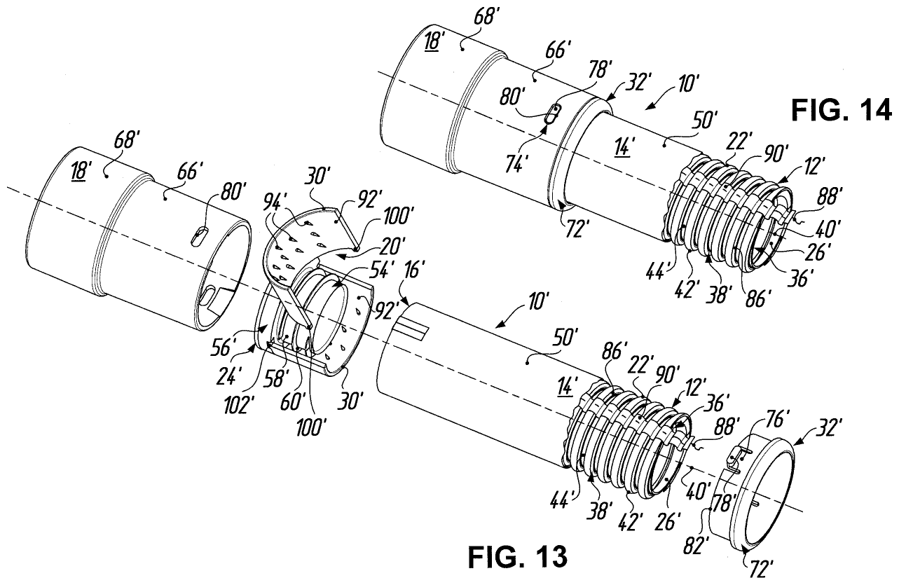

As can be further inferred from FIGS. 12 and 13, each of the retaining elements 92′ has at its side facing the sheathing 14′ a plurality of projections 94′ which are of web-like or spike-like construction for the purpose, during joining, of hooking into the sheathing 14′ or penetrating the sheathing 14′ towards the inner hose 12′, as shown in FIG. 12. Advantageously, the projections 94′ are in that case inclined towards the end 16′ of the inner hose 12′, as can be seen in FIG. 12, which on the one hand facilitates production of such projections 94′ by injection molding (simple removal from mold) and on the other hand improves function, because the projections 94′ when folding in of the retaining elements 92′ takes place impinge substantially normally on the sheathing 14′, so that they do not bend over, and then bias the sheathing 14′ in the direction of the collar section 56′ of the retaining sleeve 24′.

In addition, in the illustrated embodiment it is provided that the connecting member 18′ and the retaining sleeve 24′ with the retaining elements 92′ inclusive of projections 94′ comprise an electrically conductive material, as described in the above earlier patent application. In that regard, electrical contacting of the electrically conductive track 86′ provided at the outer circumference 22′ of the inner hose 12′ by the projections 94′ takes place as shown in FIG. 12. Alternatively or additionally thereto the projections 94′ can also contact the electrically conductive thread or threads 88′ as a consequence of penetration of the sheathing 14′.

The afore-described flexible hose 10′ according to the second embodiment can, for example, be made up as follows: Firstly, the profiled inner hose 12′ is cut to predetermined length and braided with monofilamentary and/or multifilamentary plastics material threads in order to form the substantially smooth sheathing 14′. The ends of the sheathing 14′ are then cut in such a way that the sheathing 14′ terminates at least substantially flushly with the ends 16′ of the inner hose 12. In that case the electrically conductive thread 88′ with the adhesive strip 90′ can remain projecting beyond the sheathing 14′ so that it can be folded back onto the outer circumference 50′ of the sheathing 14′ as shown in FIG. 13.

In order to mount the connecting member 18′ initially the retaining ring 72′ of the connecting member lock 32′ is pushed over the end of the flexible hose 10′. The retaining sleeve 24′ is then screwed by its sleeve section 54′ by the screw contour 60′ formed thereon into the profiled inner hose 12′ until the end 16′ of the profiled inner hose 12′ is closely opposite the collar section 56′ of the retaining sleeve 24′ or bears against the collar section 56′, as shown in FIG. 15.

Subsequently, the shell-shaped retaining elements 92′ coupled by way of the film hinges 96′ are folded together until the outer edges, which in closed state extend in the direction of the longitudinal axis 40′ of the shell-shaped retaining element 92′, bear against one another. In that case, the spike-like projections 94′ penetrate the sheathing 14′, in a given case with electrical contacting of the electrically conductive track 86′ and/or the electrically conductive thread or threads 88′. At the end of this pivot movement the detent lugs 100′ at the retaining elements 92′ detent with the associated detent cut-outs 102′ at the collar section 56′ of the retaining sleeve 24′. This state is illustrated in FIG. 16.

Joining of the retaining ring 72′ of the connecting member lock 32′ to the connecting member 18′ can now take place as described for the first embodiment so as to also tension-resistantly fix the connecting member 18′ to the inner hose 24′ by way of the retaining sleeve 24′. The end result is the state shown in FIG. 17. Demounting of the connecting member 18′ and the retaining sleeve 24′, for example for repair purposes at the hose 10′, can be carried out in reverse sequence.

A flexible hose, particularly vacuum cleaner hose, has an inner hose which is profiled in wave shape and which is surrounded by a substantially smooth sheathing and provided at at least one end with a hollow connecting member. Extending in the connecting member is the inner hose with the sheathing which is secured thereat to the inner hose by way of a sheathing lock. In addition, mounted on the inner hose is a retaining sleeve which forms a first abutment surface for the connecting member and a second abutment surface for a connecting member lock secured to the connecting member, so as to tension-resistantly and compression-resistantly fix the connecting member relative to the inner hose by way of the retaining sleeve. For simplification of assembly and improvement of repair friendliness, in particular, the sheathing in the connecting member terminates substantially flushly with the end of the inner hose or projects only slightly beyond that. In addition, the sheathing is mechanically positively mounted on the outer circumference of the inner hose by way of the sheathing lock and the retaining sleeve is mechanically positively mounted on the inner circumference of the inner hose.

### REFERENCE NUMERAL LIST

10, 10′ hose
12, 12′ inner hose
14, 14′ sheathing
16, 16′ end
18, 18′ connecting member
20, 20′ sheathing lock
22, 22′ outer circumference
24, 24′ retaining sleeve
26, 26′ inner circumference
28, 28′ first abutment surface
30, 30′ second abutment surface
32, 32′ connecting member lock
34, 34′ wall
36, 36′ cavity
38, 38′ profiling
40, 40′ longitudinal axis
42, 42′ wave crest
44, 44′ wave valley
46, 46′ hot-melt adhesive
48 braiding
50, 50′ outer circumference
52 spring steel ring
54, 54′ sleeve section
56, 56′ collar section
58, 58′ outer circumference
60, 60′ complementary contour, screw contour
62, 62′ web
64, 64′ annular projection
66, 66′ sleeve section
68, 68′ sleeve section
70, 70′ annular partition wall
72, 72′ retaining ring
74, 74′ detent connection
76, 76′ spring arms
78, 78′ detent lug
80, 80′ detent window
82, 82′ end surface
84 spacer sleeve
86′ electrically conductive track
88′ electrically conductive thread
90′ adhesive strip
92′ retaining element
94′ projection
96′ film hinge
98′ detent connection
100′ detent lug
102′ detent cut-out

What is claimed is:

1. A flexible hose (10, 10′), with an inner hose (12, 12′), which is profiled in wave shape and surrounded by a smooth sheathing (14, 14′) and which is provided at at least one end (16, 16′) with a hollow connecting member (18, 18′), into which the inner hose (12, 12′) with the sheathing (14, 14′) extends and in which the sheathing (14, 14′) is secured to the inner hose (12, 12′) by way of a sheathing lock (20, 20′), wherein a retaining sleeve (24, 24′) is mounted on the inner hose (12, 12′), the sleeve forming a first abutment surface (28, 28′) for the connecting member (18, 18′) and having a second abutment surface (30, 30′) for a connecting member lock (32, 32′), which is secured to the connecting member (18, 18′) so as to fix the connecting member (18, 18′) tension-resistantly and compression-resistantly with respect to the inner hose (12, 12′) by way of the retaining sleeve (24, 24′), characterized in that the sheathing (14, 14′) in the connecting member (18, 18′) ends either flushly with the end (16, 16′) of the inner hose (12, 12′) or projects axially slightly beyond the end (16, 16′) of the inner hose (12, 12′), wherein the sheathing lock (20, 20′) mechanically positively fixes the sheathing (14, 14′) to the outer circumference (22, 22′) of the inner hose (12, 12′), when the retaining sleeve (24, 24′) is mechanically positively secured to the inner circumference (26, 26′) of the inner hose (12, 12′).

2. A flexible hose (10, 10′) according to claim 1, characterized in that the retaining sleeve (24, 24′) is constructed in the form of a collar sleeve, with a sleeve section (54, 54′) joinable to the inner circumference (26, 26′) of the inner hose (12, 12′) and a collar section (56, 56′) which is connected with the sleeve section (54, 54′) and which forms the first and second abutment surfaces (28, 28′; 30, 30′).

3. A flexible hose (10, 10′) according to claim 2, characterized in that at least one projection, which extends in radial direction, for mechanically positive engagement with the wave-shaped profiling (38, 38′) of the inner hose (12, 12′) or a contour (60, 60′) complementary with the wave-shaped profiling (38, 38′) of the inner hose (12, 12′) is formed at the outer circumference (58, 58′) of the sleeve section (54, 54′) of the retaining sleeve (24, 24′).

4. A flexible hose (10, 10′) according to claim 3, characterized in that the wave-shaped profiling (38, 38′) of the inner hose (12, 12′) has alternating wave crests (42, 42′) and wave valleys (44, 44′) which as seen in circumferential direction of the inner hose (12, 12′) extend helically with a single start or multiple start, wherein the contour (60, 60′), which is complementary with the wave-shaped profiling (38, 38′) of the inner hose (12, 12′), at the outer circumference (58, 58′) of the sleeve section (54, 54′) of the retaining sleeve (24, 24′) is a screw contour.

5. A flexible hose (10, 10′) according to claim 4, characterized in that the sheathing lock (20, 20′) is arranged axially in the region of the retaining sleeve (24, 24′) so that the retaining sleeve (24, 24′) forms a counter-bearing for the inner hose (12, 12′) when the sheathing (14, 14′) is secured to the inner hose (12, 12′) by way of the sheathing lock (20, 20′).

6. A flexible hose (10, 40′) according to claim 5, characterized in that the sheathing lock (20) comprises a spring steel ring (52) which can be mounted on the outer circumference (50) of the sheathing (14) and which mechanically positively fixes the sheathing (14) to the wave-shaped profiling (38) at the outer circumference (22) of the inner hose (12).

7. A flexible hose (10′) according to claim 5, characterized in that the sheathing lock (20′) is formed integrally with the retaining sleeve (24′).

8. A flexible hose (10′) according to claim 7, characterized in that the sheathing lock (20′) comprises at least one retaining element (92′), which is placeable against the outer circumference (50′) of the sheathing (14′) and which has at its side facing the sheathing (14′) at least one projection (94′) mechanically positively securing the sheathing (14′) to the wave-shaped profiling (38′) at the outer circumference (22′) of the inner hose (12′).

9. A flexible hose (10′) according to claim 8, characterized in that the sheathing lock (20′) comprises at least two shell-shaped retaining elements (92′) which are pivotably connected in hinge-like manner with the collar section (56′) of the retaining sleeve (24′).

10. A flexible hose (10′) according to claim 9, characterized in that the shell-shaped retaining elements (92′) are coupled to the collar section (56′) of the retaining sleeve (24′) by way of film hinges (96′).

11. A flexible hose (10′) according to claim 9, characterized in that the shell-shaped retaining elements (92′) are detentable with the collar section (56′) of the retaining sleeve (24′) by a detent connection (98′).

12. A flexible hose (10′) according to claim 8, characterized in that the or each retaining element (92′) has at the side thereof facing the sheathing (14′) a plurality of projections (94′) which are formed in web-like or spike-like manner for the purpose of hooking into the sheathing (14′) or penetrating the sheathing (14′) towards the inner hose (12′) during joining.

13. A flexible hose (10′) according to claim 12, characterized in that the projections (94′) are inclined towards the end (16′) of the inner hose (12′).

14. A flexible hose (10′) according to claim 12, characterized in that the connecting member (18′), the retaining sleeve (24′) and the retaining element or elements (92′) together with the projections (94′) thereof comprise an electrically conductive material and at least one electrically conductive track (86′) extending around the inner hose (12′) is provided at the outer circumference (22′) of the inner hose (12′), wherein the projections (94′) electrically contact the electrically conductive track (86′).

15. A flexible hose (10′) according to claim 14, characterized in that the electrically conductive track (86′) is in electrical contact with at least one electrically conductive thread (88′) which electrically connects the mutually remote ends (16′) of the inner hose (12′) as well as extends substantially along a longitudinal axis (40′) of the inner hose (12′) and transversely to the electrically conductive track (86′) and is secured to the outer circumference (22′) of the inner hose (12′), wherein the projections (94′) electrically contact the electrically conductive thread (88′).

16. A flexible hose (10, 10′) according to claim 1, characterized in that the connecting member lock (32, 32′) comprises a retaining ring (72, 72′) which can be secured to the connecting member (18, 18′) and is supported relative to the second abutment surface (30, 30′) of the retaining sleeve (24, 24′) by way of a spacer which is formed by a separate spacer sleeve (84) or the shell-shaped retaining elements (92′) of the sheathing lock (20′).

17. A flexible hose (10, 10′) according to claim 1, characterized in that the sheathing (14, 14′) is a braiding of monofilamentary and/or multifilamentary plastics material threads.

18. A flexible hose (10, 10′) according to claim 1, characterized in that the sheathing lock (20, 20′) is arranged axially in the region of the retaining sleeve (24, 24′) so that the retaining sleeve (24, 24′) forms a counter-bearing for the inner hose (12, 12′) when the sheathing (14, 14′) is secured to the inner hose (12, 12′) by way of the sheathing lock (20, 20′).

19. A flexible hose (10) according to claim 1, characterized in that the sheathing lock (20) comprises a spring steel ring (52) which can be mounted on the outer circumference (50) of the sheathing (14) and which mechanically positively fixes the sheathing (14) to the wave-shaped profiling (38) at the outer circumference (22) of the inner hose (12).

20. A flexible hose (10′) according to claim 1, characterized in that the sheathing lock (20′) comprises at least one retaining element (92′), which is placeable against the outer circumference (50′) of the sheathing (14′) and which has at its side facing the sheathing (14′) at least one projection (94′) mechanically positively securing the sheathing (14′) to the wave-shaped profiling (38′) at the outer circumference (22′) of the inner hose (12′).
